(19) United States
(12) Patent Application Publication
(10) Pub. No.: US 2006/0198322 A1
(43) Pub. Date: Sep. 7, 2006

(54) Method and apparatus for BGP peer prefix limits exchange with multi-level control

(76) Inventor: Susan Hares, Saline, MI (US)

Correspondence Address: PERKINS COIE LLP, P.O. BOX 2168, MENLO PARK, CA, 94026, US

(21) Appl. No.: 11/122,991

(22) Filed: May 4, 2005

Related U.S. Application Data
(60) Provisional application No. 60/658,079, filed on Mar. 3, 2005.

(51) Int. Cl. H04L 12/28; H04L 12/56

(52) U.S. Cl. 370/254; 370/401

(57) ABSTRACT

Method and apparatus for exchanging route prefix limit parameters and performing route processing based on multi-level, e.g., three levels of prefix limit parameters between BGP peers in a network running BGP protocol. Further, a route refresh BGP message and/or a soft-notify BGP message may be used to exchange prefix limit related information, according to certain embodiments.

This application claims the benefit of U.S. Provisional Application No. 60/506,018, filed on Sep. 24, 2003, U.S. Provisional Application No. 60/568,079, filed on May 4, 2004, US patent application entitled, Method and Apparatus For BGP Peer Prefix Limits Exchange With Multi-Level Control by Hares et al., all of are herein incorporated by reference.

The present invention relates generally to communication networks and, more particularly, to a method and apparatus for exchanging route prefix limits related information and performing route processing based on multi-level limits between Border Gateway Protocol (BGP) peers, and a BGP route refresh.

### BACKGROUND OF THE INVENTION

In the basic BGP protocol, BGP speaker announces all routes permitted by BGP policy to peers. With the introduction of new services such as the Virtual Private Networks (VPN) services, the use of additional private routes becomes another potential for unexpected route overload based on misconfiguration and new addition of routes. Denial of service attacks based on sending additional specific routes or VPN routes are also a potential of router overload due to route advertisements.

The operators of two peered BGP speakers may manually coordinate the configurations between the two BGP devices to avoid overload due to route advertisements; however, network changes, misconfigurations, miscommunications, or other factors frequently will also result in situations where the number of prefixes advertised from a BGP sender to a BGP receiver exceeds the expected limit.

When the limit is exceeded, then there are generally two options: the prefixes exceeding the limit can be dropped by the BGP receiver, or the peering session may be terminated by the BGP receiver and restarted at a later time. Neither of these options is desirable. Until the configurations can be modified, the various service affecting disruptions continue, and the operator works with the customer to correct the problem and restart the session.

There are further implications of this process. First, the provider proves to the customer that the session drop was due to customer violating the agreed maximum prefix limit rather than being due to the operator's network condition causing the session drop. Secondly, the operator works with customer to locate the root cause, and more likely manually bring back the BGP peering session at an agreed time. This is labor intensive for the operator and the customer. Finally, the customer may be extremely unhappy about the session drop regardless of the reason. Due to the above reasons, as the current common practice, a provider may choose not to use the maximum prefix limit feature for their Internet services to avoid operations complications. However, the introduction of new MPLS based Virtual Private Networks (VPN) services, the use of additional private routes becomes a real potential for unexpected route overload based on misconfiguration and new addition of VPN routes.

Therefore a need exists for a method and apparatus by which BGP peers can exchange multi-level, e.g., three levels of prefix limit related information and status and perform route processing based on the established limits so that service providers can proactively manage their BGP connections to avoid or contain service affecting events in a predictable manner.

### SUMMARY OF THE INVENTION

In one embodiment, the present invention improves the stability of a network by providing a mechanism by which BGP peers can exchange multi-level, e.g., three levels of prefix limit related information and status and perform route processing based on the established limits to avoid or reduce service affecting events. If the number of prefixes approaches the known limit, both peers can provide multiple levels of warnings to their respective operators, and even if the limit is reached, both devices can behave in a manner to preserve network stability until the operators can address the cause of the excessive prefix condition. Further, a route refresh BGP message and/or a soft-notify BGP message may be used to exchange prefix limit related information, according to certain embodiments.

### BRIEF DESCRIPTION OF THE DRAWINGS

The teaching of the present invention can be readily understood by considering the following detailed description in conjunction with the accompanying drawings, in which:

FIG. 1 illustrates a block diagram of a communication network comprising a plurality of Autonomous Systems (AS) operated by different service providers, BGP routers interconnected by communication links;

FIG. 2 illustrates a message format of the optional capability that encodes the various prefix limit parameters;

FIG. 3 illustrates a flowchart of the method of initial prefix limit negotiation operations by a BGP receiver;

FIG. 4 illustrates a flowchart of the method of normal route processing operations based on prefix limit parameters by a BGP receiver;

FIG. 5 illustrates a flowchart of the method of route processing operations when the maximum prefix limit has been reached or exceeded by a BGP receiver;

FIG. 6 illustrates a flowchart of the method of initial prefix limit negotiation operations by a BGP sender;

FIG. 7 illustrates a flowchart of the method of normal route processing operations based on prefix limit parameters by a BGP sender; and

FIG. 8 illustrates a flowchart of the method of route processing operations when the maximum prefix limit has been reached or exceeded by a BGP sender.

FIG. 9 illustrates another exemplary message encoding and format 900, according to certain embodiments.

FIG. 10 illustrates the layout of bytes for additional sub code fields associated with the optional capability parameter, BGP-CAP, in the BGP-OPEN message, according to certain embodiments.

FIG. 11 illustrates the encoding of the triples of the BGP OPEN capabilities field, according to certain embodiments.

FIG. 12 illustrates the fields in the Capability message, according to certain embodiments.

FIG. 13 illustrates the BGP Route-Refresh message [BGP-rr], according to certain embodiments.

FIG. 14 illustrates a soft notify message, according to certain embodiments.

FIG. 15 illustrates BGP speakers A and B, according to certain embodiments.

FIG. 16 illustrates BGP speaker B detecting a warning message from A of a prefix limit, according to certain embodiments.

FIG. 17 illustrates BGP speaker B detecting a Stop Advertisement message from A, according to certain embodiments.

### DETAILED DESCRIPTION

The present invention relates to data communication networks. These networks include, but are not limited to, a network of routers running BGP protocol or a network supporting VPN services using BGP protocol.

These networks consist of a number of BGP routers connected by communication links. There are various scenarios where BGP peering may be established between two speakers in which there is an expectation that some limited number of prefixes will be announced by a given speaker. For the purpose of this disclosure, a prefix is defined as a line segment of an IP address space. In these scenarios, if the expected number of prefixes is exceeded, then the peering session may be disrupted. The disruption may be due to a specific configuration which is functioning properly in order to prevent an overload condition, or it may occur when the receiving BGP speaker becomes overloaded and suffers various consequences.

The term “BGP sender” (or “sender”) refers to a BGP speaker which is advertising prefixes to its peer. The term “BGP receiver” (or “receiver”) refers to a BGP speaker which is receiving prefixes from its peer. A BGP speaker will typically be both a BGP sender and receiver.

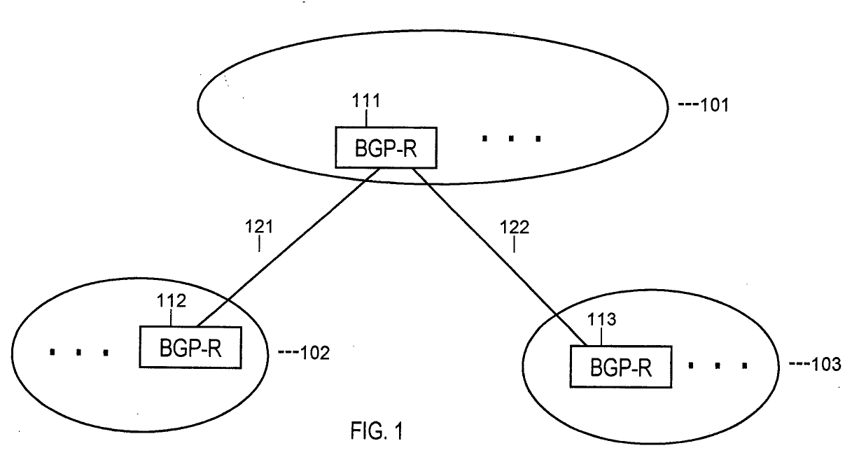

To better understand the present invention, a description of the components of such communication networks is provided below. FIG. 1 shows an exemplary communication network, according to certain embodiments. The communication network comprises a plurality of Autonomous Systems (AS) operated by different service providers 101-103, BGP routers (BGP-R) 111-113 and links 121-122. Autonomous Systems (AS) 101 and 102 run by separate operators are interconnected using BGP routers 111 and 112 by link 121, and AS 101 and 103 run by separate operators are interconnected using BGP routers 111 and 113 by link 122. In FIG. 1, BGP speaker 111 has two peers, one is router 112 and another one is router 113. In general, a BGP router may have one or more peers.

In the basic BGP protocol, BGP speaker announces all routes permitted by BGP policy to peers. To illustrate this using FIG. 1, the operators, 101 and 102, of two peered BGP speakers, 111 and 112, may manually coordinate the configurations between the two BGP devices, 111 and 112. Similarly, the operators, 101 and 103, of two peered BGP speakers, 111 and 113, may manually coordinate the configurations between the two BGP devices, 111 and 113.

With the introduction of new services such as the Virtual Private Networks (VPN) services, the use of additional private routes becomes a real potential for unexpected route overload based on misconfiguration and new addition of routes. Denial of service attacks based on sending additional specific routes or VPN routes are also a potential for unexpected router overload. Even though the operators of two peered BGP speakers may coordinate the configurations between the two BGP devices, network changes, misconfigurations, miscommunications, or other factors frequently will also result in situations where the number of prefixes advertised from a BGP sender, say 112, to a BGP receiver, say 111, will exceed the expected limit. Until the configurations can be modified, various service affecting disruptions may result.

When the expected number of prefixes is exceeded, regardless of any of the aforementioned reasons, then the peering session may be disrupted. The prefixes exceeding the limit can be dropped by the BGP receiver 111, or the peering session may be terminated by the BGP receiver 111 and restarted at a later time. The result of these actions will be service affecting. Dropping prefixes leads to network unreliability, since the dropped prefixes advertised by BGP sender 112 will be unreachable through the BGP receiver 111. Terminating the BGP session will cause all traffic between the peers, 111 and 112, to be disrupted, even for those prefixes which were advertised before the limit was reached. Other undesirable effects include resource utilization on the peers from restarting the peering session, and the processing load and bandwidth utilization from withdrawing and re-advertising the prefixes throughout the Internet.

Note also that each BGP speaker can act as a sender and a receiver at the same time; therefore, the aforementioned example and associated consequences will also apply if BGP speaker 111 acts as the sender and BGP speaker 112 acts as the receiver.

Similarly, the aforementioned example is also applicable between BGP speaker 113 and BGP speaker 111 as well. Normally, a BGP speaker can have one or more peers within a network, as is the case for BGP speaker 111 as shown in FIG. 1.

To address this criticality, according to certain embodiments, a method and apparatus are provided for coordinating the setting of a limit on the number of prefixes, exchanging prefix limit related status information, and performing route processing based on such limits between BGP peers. According to certain embodiments, the stability of a network is improved by providing a mechanism by which BGP peers can exchange multi-level, e.g., three levels of prefix limit related information and status to avoid or reduce service affecting events.

In one embodiment, the first level limit triggers the warning on both BGP receiver and sender devices, so the BGP sender can act on it without waiting for the operator of the BGP receiver to call as the warning prefix limit (e.g., a first prefix limit) is reached. The second level limit triggers the BGP sender device to stop sending route advertisements to the BGP receiver device, as the agreed maximum prefix limit (e.g., a second prefix limit) is reached. Additionally, this may also result in alarms being issued on both the BGP sender and the BGP receiver devices with or without the stopping of the route advertisement. The idea is to have the customer take action to fix the problem without dropping the BGP session, thereby requiring less human intervention from the provider side. The third level of prefix limit triggers the session drop action from the BGP receiver side as the reset prefix limit (e.g., a third prefix limit) is reached. This is used as a safeguard by the BGP receiver operator in case the BGP sender device did not behave as expected and is continuing to send routes after exceeding the second level prefix limit threshold.

Although the present communication network may employ BGP routing protocol, those skilled in the art will realize that variants of the standard BGP protocol or any routing protocols that require exchanging route limit information can be adapted to various embodiments of the invention.

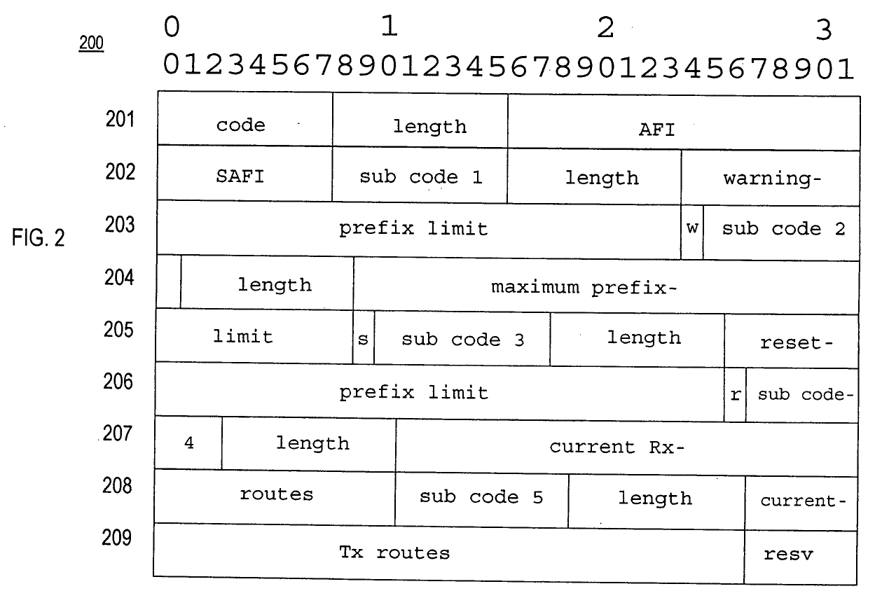

FIG. 2 illustrates an exemplary message encoding and format 200 in one embodiment of the present invention that can be used to exchange prefix limit information using the optional capability parameter, BGP-CAP, in the BGP-OPEN message by each BGP speaker. In one embodiment, the entire prefix limit parameter may comprise a total of 9 32-bit words, 201 to 209.

In word 201, there is an 8-bit code field with a unique code to identify the prefix limit exchange capability, an 8-bit length field that is set to a value of 34 octets to indicate the length of the prefix limit parameter capability value field, and a 16 bit Address Family Identifier (AFI) field which is used in conjunction with the SAFI field to identify the network layer protocol associated with the network address. A prefix or a route can be implicitly inferred as an address belonging to any AFI/SAFI pair. For example, the present methods can be applied to VPNv4 address family, or IPv6 address family.

In word 202, there is an 8-bit Subsequent Address Family Indicator (SAFI) field which is used in conjunction with the AFI field to identify the network layer protocol associated with the network address, an 8-bit sub code 1 field which is used to uniquely identify the warning prefix limit parameter capability feature, an 8-bit length field that indicates the length of the warning prefix limit field which is set to the value of 4 octets, and the first 8 bits of the 32-bit warning prefix limit field. The warning prefix limit field indicates the actual number of routes that can be sent by a BGP sender before warning prefix limit threshold is exceeded.

In word 203, there is the last 24 bits of the 32-bit warning prefix limit field, a 1-bit warning action indicator field, and the first 7 bits of the 8-bit sub code 2 field. The 1-bit warning action indicator field can be set to a value of 0 or 1. When its value is set to 1, it means the warning indication is necessary and is used by both the BGP sender and the BGP receiver when the number of routes advertised equals the warning prefix limit set by the BGP receiver. A value of 0 means that a BGP speaker should not raise any warning to its corresponding peer. The sub-code 2 field is used to uniquely identify the maximum prefix limit parameter capability.

In word 204, there is the last 1 bit of the 8-bit sub code 2 field, an 8-bit length field that indicates the length of the maximum prefix limit field which is set to the value of 4 octets, and the first 23 bits of the 32-bit maximum prefix limit field which is used to indicate the actual number of routes that can be sent by a BGP sender before maximum prefix limit threshold is exceeded.

In word 205, there is the last 9 bits of the 32-bit maximum prefix limit field, a 1-bit stop advertisement action indicator field, an 8-bit sub code 3 field, an 8-bit length field that indicates the length of the reset prefix limit field which is set to the value of 4 octets, and the first 6 bits of the 32-bit reset prefix limit field. The 1-bit stop advertisement action indicator field is set to a value of 1 which means that route advertisement stopped by the BGP sender if the maximum prefix limit threshold is reached. The sub-code 3 field is used to uniquely identify the reset prefix limit parameter capability. The reset prefix limit field is used to indicate the number of routes that can be sent by a BGP sender before the reset prefix threshold is exceeded.

In word 206, there is the last 26 bits of the reset prefix limit field, a 1-bit reset peering action indicator, and the first 5 bits of the sub code 4 field. The reset peering action indicator is set to a value of 1 which means that the BGP receiver will reset the peering session if the number of routes advertised by a BGP sender exceeds the reset prefix limit threshold. The sub code 4 field is used to uniquely identify the current Rx routes parameter capability.

In word 207, there is the last 3 bits of the 8-bit sub code 4 field, an 8-bit length field that indicates the length of the current Rx routes field which is set to the value of 4 octets, and the first 21 bits of the 32-bit current Rx routes field. The current Rx routes field is sent by a BGP speaker to its corresponding BGP peer to indicate the number of advertised routes received by the BGP speaker from its corresponding BGP peer.

In word 208, there is the last 11 bits of the 32-bit current Rx routes field, an 8-bit sub code 5 field, an 8-bit length field that indicates the length of the current Tx routes field which is set to the value of 4 octets, and the first 5 bits of the 32-bit current Tx routes field. The sub code 5 field is used to uniquely identify the current Tx routes parameter capability. The current Tx routes field is sent by a BGP speaker to its corresponding BGP peer to indicate the number of advertised routes sent by the BGP speaker to its corresponding BGP peer.

In word 209, there is the last 24 bits of the 32-bit Tx Routes field and an 8-bit resv field. The resv field shall be set to 0 when it is sent and shall be ignored when received.

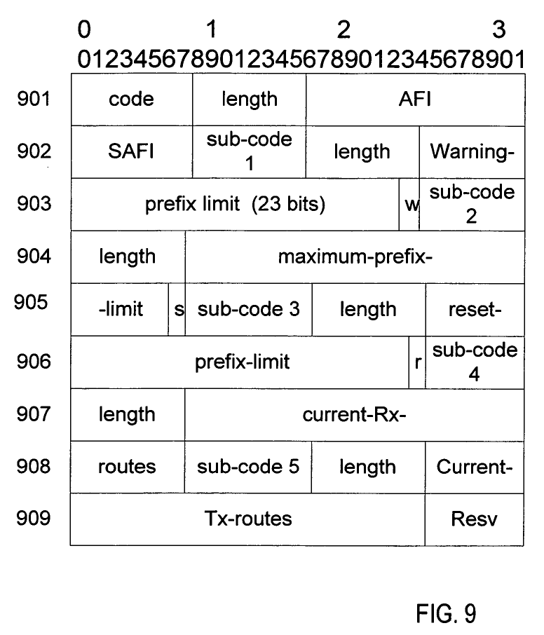

FIG. 9 illustrates another exemplary message encoding and format 900, according to certain embodiments. Message encoding and format 900 can be used to exchange prefix limit information using the optional capability parameter, BGP-CAP in the BGP-OPEN message. Prefix limit parameter may comprise a total message managed by each BGP speaker. In one embodiment, Prefix limit parameter may comprise the entire nine 32-bit words, 901 to 909.

In word 901, there is an 8-bit code field with a unique code to identify the prefix limit exchange capability, an 8-bit length field that is set to a value of 34 octets to indicate the length of the prefix limit parameter capability value field, and a 16 bit Address Family Identifier (AFI) field which is used in conjunction with the SAFI field to identify the network layer protocol associated with the network address.

In word 902, there is an 8-bit Subsequent Address Family Indicator (SAFI) field which is used in conjunction with the AFI field to identify the network layer protocol associated with the network address, an 8 bit sub-code 1 which is used to uniquely identify the warning prefix parameter capability feature, an 8 bit-length field that indicates the length of the warning prefix limit field which is set to the value of 4 octets, and the first 8 bits of the 31-bit warning prefix limit field. The warning prefix limit field indicates the actual number of routes that can be sent by a BGP sender before the warning prefix limit threshold is exceeded.

In word 903, there is the last 23 bits of the 31-bit warning prefix limit field, a 1-bit warning action, and an 8-bit sub-code 2 field. The 1-bit warning action indicator field can be set to a value of 0 or 1. In an alternative embodiment, the 1-bit warning action indicator field can be set to a value of 2. When its value is set to 1, it means the warning indication is necessary and should be used by both the BGP sender and the BGP receiver when the number of routes advertised equals the warning prefix limit set by the receiver. A value of 0 means that a BGP speaker should not raise any warning to its corresponding peer. A value of 2 indicates that such a BGP message will be transmitted to the remote peer if the route advertisement limit is reached. The sub-code 2 field is used to uniquely identify the maximum prefix limit parameter capability.

In word 904, there is an 8-bit length field that indicates the length of the maximum prefix limit field which is set to the value of 4 octets, and the first 24 bits of the 31-bit maximum prefix limit field which is used to indicate the actual number of routes that can be sent by a BGP sender before the maximum prefix limit threshold is exceeded.

In word 905, there is the last 7 bits of the 31-bit maximum prefix limit field, a 1-bit stop advertisement action indicator field, an 8-bit sub-code 3 field, an 8-bit length field that indicates the length of the rest prefix limit field which is set to the value of 4 octets, and the first 8 bits of the 31-bit reset prefix limit field. The 1-bit stop advertisement action indicator field is set to a value of 1 which means that the route advertisement is stopped by the BGP sender if the maximum prefix limit threshold is reached. In an alternate embodiment, the 1-bit stop advertisement action indicator field may be set to a value of 0 or 2. A value of 0 indicates that the BGP sender will ignore routes sent after the stop advertisement limit is reached. A value of 2 indicates that the BGP message will be transmitted to the remote peer if the route advertisement limit is reached. The sub-code 3 field is used to uniquely identify the rest of the prefix limit parameter capability. The reset prefix limit field is used to indicate the number of routes that can be sent by a BGP speaker before the reset prefix limit threshold is exceeded.

In word 906, there is the last 27 bits of the reset prefix limit field, a 1-bit reset peering action indicator, and an 8-bit sub code 4 field. The reset peering action indicator is set to a value of 1 which means that the BGP receiver will reset the peering session if the number of routes advertised by a BGP sender exceeds the reset prefix limit threshold. In an alternate embodiment, the reset peering action indicator field may be set to a value of 0, 1 or 2. In such a case, a value of 0 indicates that the BGP sender will reset the peering session if the number of routes advertised by a BGP sender exceeds the reset prefix limit threshold. A value of 1 indicates that the BGP peer will reset the peering session and hold it down until a manual restart occurs. A value of 2 indicates that the BGP peer will reset the peering session via a mechanism such as a soft-notify. The Sub code field 4 is used to uniquely identify the current Rx routes parameter capability.

In word 907, there is an 8-bit length field that indicates the length of the current Rx routes field which is set to the value of 4 octets, and the first 24 bits of the 32-bit current Rx route field. The current Rx routes field is sent by a BGP speaker to the corresponding BGP peer to indicate the number of advertised routes received by the BGP speaker from its corresponding BGP peer.

In word 908, there is the last 8 bits of the 32-bit current Rx Routes field, an 8-bit sub code 5 field, an 8-bit length field that indicates the length of the current Tx routes field, and the first 8-bits of the 32-bit current Tx routes field. The sub-code 5 field is used to uniquely identify the current Tx routes parameter capability. The current Tx routes field is sent by a BGP speaker to its corresponding BGP peer to indicate the number of advertised routes sent by the BGP speaker to its corresponding BGP peer.

In word 909, there is the last 24 bits of the 32-bit Tx Routes field and an 8-bit resv field. The resv field shall be set to 0 when it is sent and shall be ignored when received.

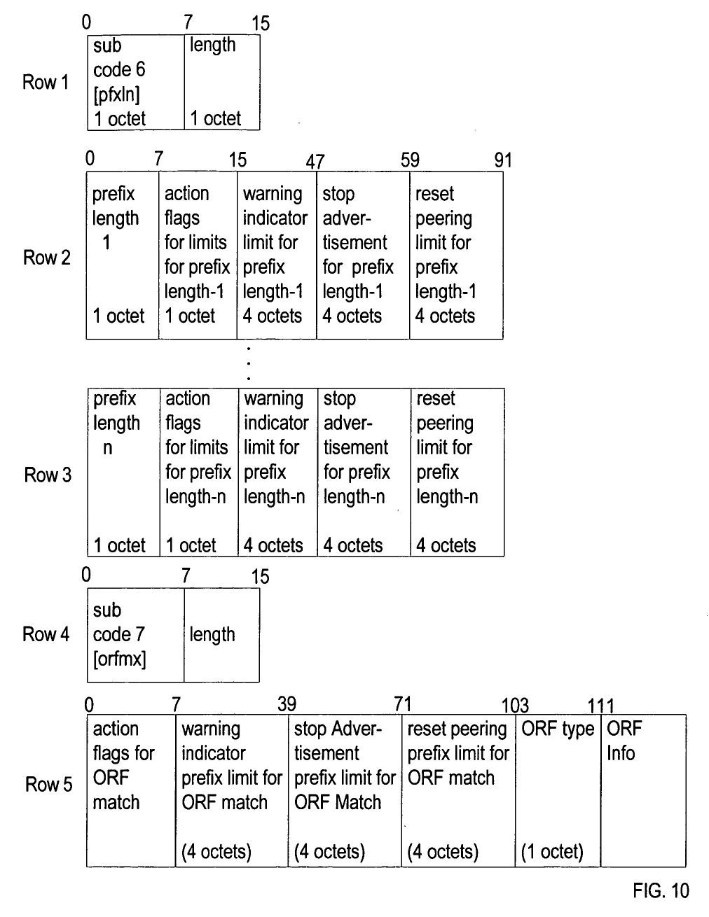

FIG. 10 illustrates the layout of bytes for additional sub code fields associated with the optional capability parameter, BGP-CAP, in the BGP-OPEN message, according to certain embodiments.

Row 1 of FIG. 10 shows a sub-code 6 field and a length field. BGP speakers use sub-code 6 to indicate a set of prefix-length limits, such as warning limit, stop advertisement limit, and reset limit. The sub-code 6 field carries an action flag that indicates actions that occur for all prefixes that hit prefix-length limits, and the limits per length of the prefix. An example of a length of a prefix is length 19 for all /19 routes. All /19 routes will have a warning limit, a stop advertisement limit and a reset limit.

Row 2 of FIG. 10 shows a prefix length-1 field, an action-flags for prefix-1 field, warning prefix limit for prefix length-1 field, stop advertisement limit for prefix length-1 field, and a reset peering limit for prefix length field.

The prefix length-1 field indicates the length (in bits) of the prefix group. The action-flags for prefix-1 are the action flag octet that carries the set of action flags for all prefix in the following bit pattern: 0x00WWSSRR. The WW bits can be set with the warning indicator values (0,1,2) indicated in sub-code 1. The SS bits can be set with the stop advertisement action values (0,1,2) indicated in sub-code 2. The RR bits can be set to the rest action values (0,1,2) indicated in sub-code 3.

The warning prefix limit for prefix length-1 field indicates the warning limit for the prefix length-1. The stop advertisement limit for prefix length-1 field indicates the stop advertisement prefix limit for prefix length-1.

The reset peering limit for prefix length field indicates the reset peering route limit for the prefix of length-1.

Row 3 of FIG. 10 has fields that are similar to row 2 except that in row 3, the fields are with respect to prefix lengthen.

Row 4 of FIG. 10 shows a sub-code 7 field, and a length field. Sub-code 7 allows the 3 basic prefix limits for the set of prefixes matching the outbound router filters (ORFs). Multiple sub-code 7 TLVs may be in a Prefix TLV.

Row 5 of FIG. 10 shows an action flags for ORF field, a warning indicator prefix limit for ORF match field, a stop advertisement prefix limit for ORF match field, a reset peering prefix limit for ORF Match field, an ORF type field, and an ORF information field.

In the action flags for ORF field, the action flag definitions are the same as for the action-flag for sub-code 6 (prefix length). The warning indicator prefix limit for ORF match field indicates the warning indicator prefix limit for any prefix that matches the ORF filter. The stop advertisement prefix limit for ORF match field indicates the stop advertisement prefix limit for any prefix that matches the ORF filter. The reset peering prefix limit for ORF Match field indicates the stop peering prefix limit for any prefix that matches the ORF filter. The warning prefix limit, maximum prefix limit and the reset prefix limit are referred to herein as prefix limits for the ease of illustration.

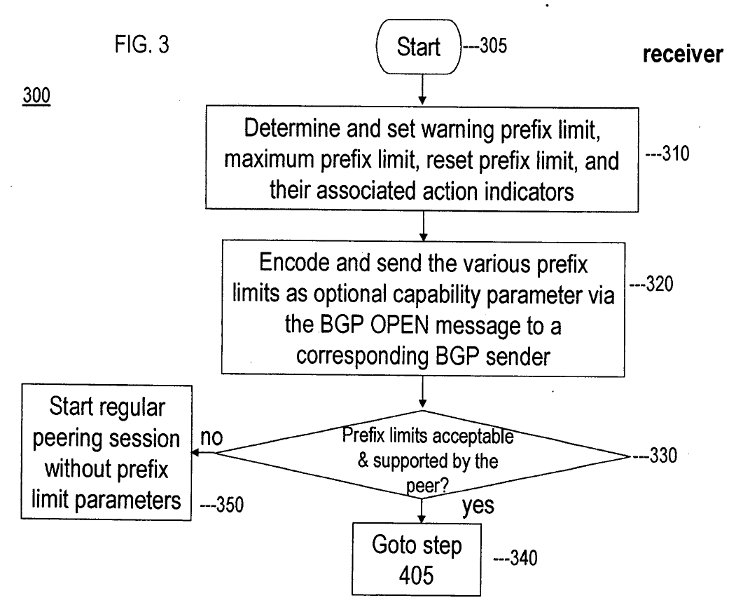

FIG. 3 illustrates a flowchart of an initial prefix limit negotiation method 300 for exchanging prefix limit parameters from a BGP receiver perspective. Method 300 starts in step 305 and proceeds to step 310.

Again using FIG. 1 as an example with router 111 as a BGP receiver and router 112 as a BGP sender, in step 310, the operator of AS 101 determines and sets the warning prefix limit, the maximum prefix limit, the reset prefix limit, and the various associated prefix limit action indicators that router 112 owned by operator 102 adheres to during route processing. In step 320, router 111 will send a BGP-OPEN message with optional capability parameters encoded with the three predetermined prefix limits set in step 310 to router 112 to begin negotiation prefix limit parameters. In step 330, if router 112 returns an acknowledgement message indicating that the prefix limit parameters are accepted and supported, then router 111 will begin normal operations of the prefix limit exchange feature and proceed to step 340 which further proceeds to step 405. If router 112 returns a NOTIFICATION message indicating that the prefix limit parameters cannot be supported, then router 111 will re-attempt to establish a BGP session with router 112 without using the prefix limit parameters optional capability.

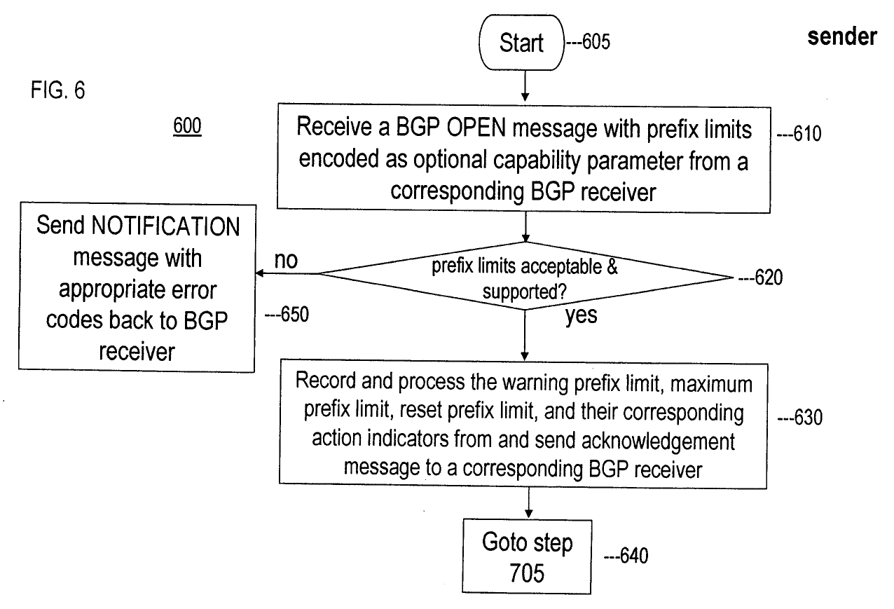

FIG. 6 illustrates a flowchart of an initial prefix limit negotiation method 600 for exchanging prefix limit parameters from a BGP sender perspective. Method 600 starts in step 605 and proceeds to step 610.

To continue using FIG. 1 as an example with router 111 as a BGP receiver and router 112 as a BGP sender, in step 610, router 112 receives a BGP-OPEN message with the optional capability of the prefix limit parameters including a set of the warning prefix limit, the maximum prefix limit, the reset prefix limit, and the various associated prefix limit action indicators that is sent by router 111. In step 620, router 112 will check if the prefix limits are supported. If router 112 supports the prefix limit exchange feature, method 600 proceeds to step 630, else method 600 proceeds to step 650. In step 630, router 112 will send an acknowledgement message to router 111 to indicate the prefix limit negotiation has succeeded. Then, router 112 will adhere to the various prefix limit parameters to begin route processing and proceeds to step 640 which further proceeds to step 705. In step 650, router 112 sends a NOTIFICATION message to router 111 to indicate prefix limit negotiation has failed.

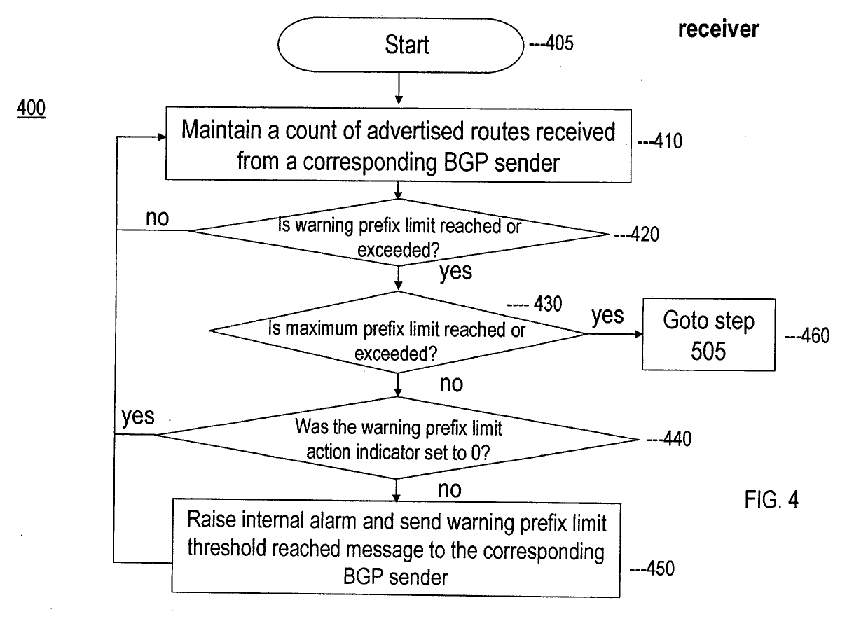

To continue with the same example, FIG. 4 illustrates a flowchart of the normal route processing method 400 of the prefix limit exchange feature from a BGP receiver perspective. Method 400 begins in step 405 and proceeds to step 410.

In step 410, BGP receiver, say router 111, begins maintaining a count of all routes advertised by BGP sender, say router 112. In step 420, router 111 checks if the warning prefix limit has been reached whenever it receives a route advertisement from router 112. If the warning prefix limit has not been reached, router 111 proceeds to step 410 to continue maintaining normal route processing. If the warning prefix limit has been reached or exceeded, router 111 will proceed to step 430. In step 430, router 111 will check if the maximum prefix limit has been reached or exceeded. If the maximum prefix limit has not been reached, router 111 proceeds to step 440. If the warning prefix limit has been reached or exceeded, router 111 will proceed to step 460 which further proceeds to step 505. In step 440, router 111 will check the setting of the warning prefix limit action indicator that has been sent to router 112 during the initial negotiation process. If the warning prefix limit indicator has been set to 0, then router 111 will proceed to step 410 to continue normal route processing. If the warning prefix limit indicator has been set to 1, then router 111 will proceed to step 450. In step 450, router 111 will raise an internal alarm to indicate that router 112 has already reached the route advertisement warning prefix limit and send, e.g., a BGP-DYN-CAP message with the current Tx routes and the current Rx routes information to router 112 to indicate the warning prefix limit has been reached. Then router 111 will proceed to step 410 to continue normal route processing.

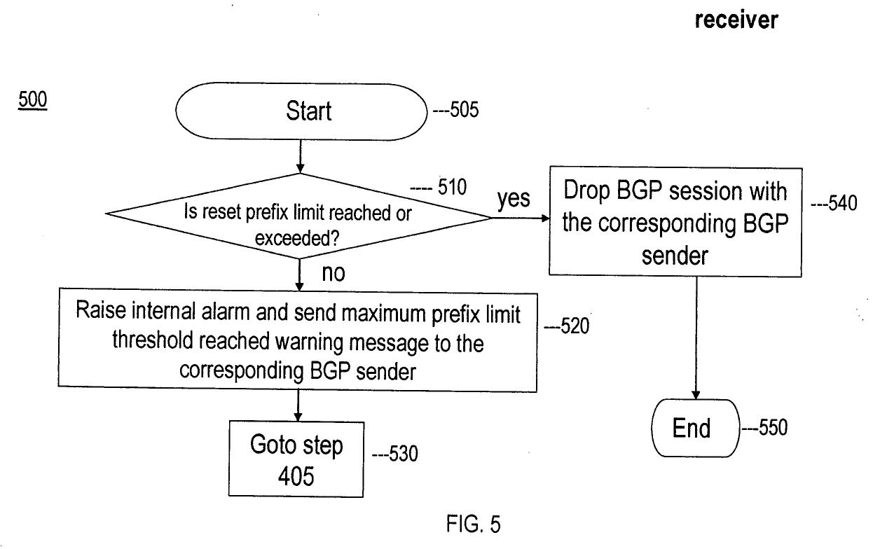

FIG. 5 illustrates a flowchart of the route processing method 500 of the prefix limit exchange feature when the maximum prefix limited is reached or exceeded from a BGP receiver perspective. Method 500 begins in step 505 and proceeds to step 510.

In step 510, the BGP receiver, router 111, checks if the reset prefix limit has been reached or exceeded by the BGP sender, router 112. If the reset prefix limit has been reached, then router 111 proceeds to step 540. In step 540, router 111 will drop the corresponding BGP session with router 112. The method ends in step 550. If the reset prefix limit has not been reached, then router 111 will proceed to step 520. In step 520, router 111 will raise an internal alarm to indicate that router 112 has already reached or exceeded the route advertisement maximum prefix limit and send, e.g., a BGP-DYN-CAP message with the current Tx routes and the current Rx routes information to router 112 to indicate the maximum prefix limit has been reached or exceeded. Then, router 111 will proceed to step 530 which further proceeds to step 405 to continue normal route processing.

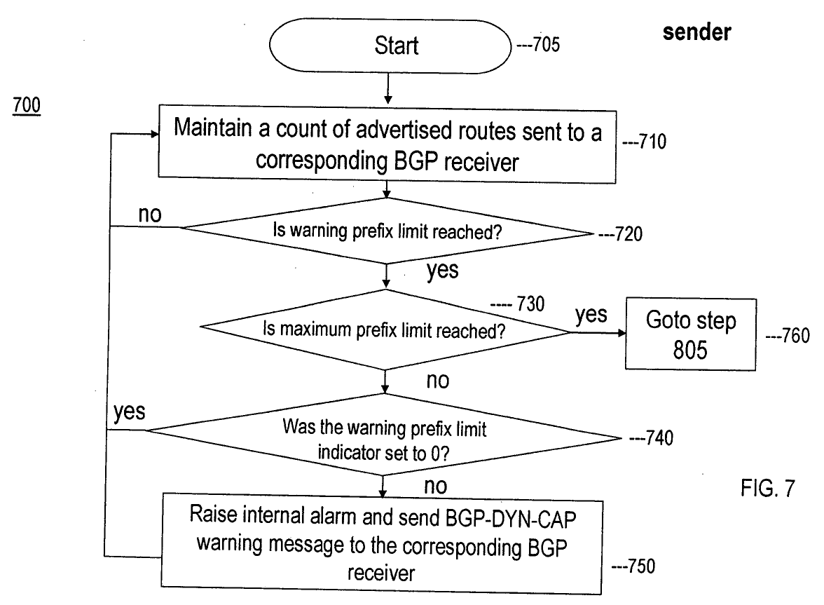

To continue with the same example, FIG. 7 illustrates a flowchart of the normal route processing method 700 of the prefix limit exchange feature from a BGP sender perspective. Method 700 begins in step 705 and proceeds to step 710.

In step 710, the BGP sender, router 112, begins maintaining a count of all routes advertised by itself to the BGP receiver, router 111. In step 720, router 112 checks if the warning prefix limit has been reached or exceeded whenever it sends a new route advertisement to router 111. If the warning prefix limit has not been reached, router 111 proceeds to step 710 to continue normal route processing. If the warning prefix limit has been reached or exceeded, router 112 will proceed to step 730. In step 730, router 112 will check if the maximum prefix limit has been reached or exceeded. If the maximum prefix limit has not been reached, router 112 proceeds to step 740. If the warning prefix limit has been reached or exceeded, router 112 will proceed to step 760 which further proceeds to step 805. In step 740, router 112 will check the setting of the warning prefix limit indicator that has been sent by router 111 during the initial negotiation process. If the warning prefix limit indicator has been set to 0, then router 112 will proceed to step 710 to continue normal route processing. If the warning prefix limit indicator has been set to 1, then router 112 will proceed to step 750. In step 750, router 112 will raise an internal alarm to indicate that it has already reached or exceeded the route advertisement warning prefix limit and send, e.g., a BGP-DYN-CAP message with the current Tx routes and the current Rx routes information to router 111 to indicate the warning prefix limit has been reached or exceeded. Then the method will proceed to step 710 to continue normal route processing.

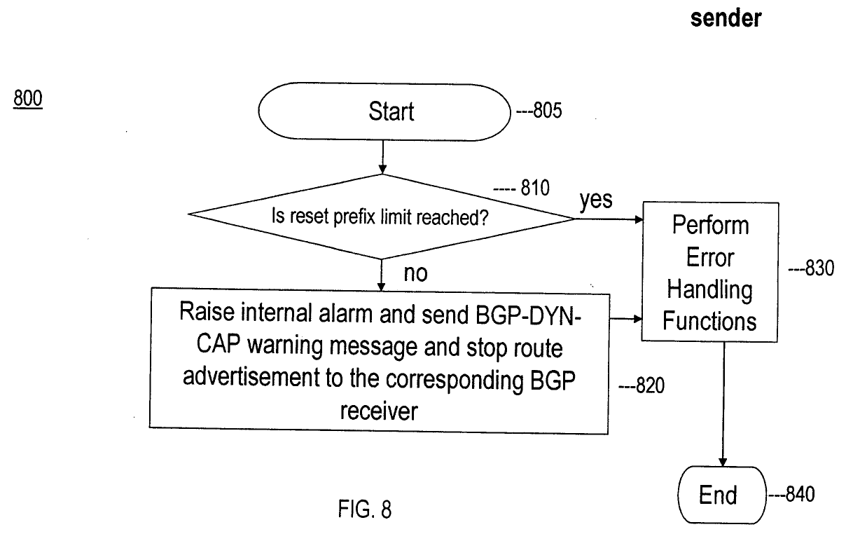

FIG. 8 illustrates a flowchart of the route processing method 800 of the prefix limit exchange feature when the maximum prefix limit is reached or exceeded from a BGP sender perspective. Method 800 begins in step 805 and proceeds to step 810.

In step 810, BGP sender, router 112, checks if the reset prefix limit has been reached or exceeded by itself. If the reset prefix limit has been reached or exceeded, then router 112 proceeds to step 830. If the reset prefix limit has not been reached, then router 112 will proceed to step 820. In step 820, router 112 will raise an internal alarm to indicate that router 112 has already reached or exceeded the route advertisement maximum prefix limit and send, e.g., a BGP-DYN-CAP message with the current Tx routes and the current Rx routes information to router 111 to indicate the maximum prefix limit has been reached or exceeded by itself. Router 112 will also stop route advertisement to router 111 and the method proceeds to step 830. In step 830, the operator of router 112 steps to correct the problem. The method terminates in step 840.

Additionally, the present prefix limit exchange methods and data structures can be represented by one or more software applications (or even a combination of software and hardware, e.g., using application specific integrated circuits (ASIC)), where the software is loaded from a storage medium, (e.g., a ROM, a magnetic or optical drive or diskette) and operated by the CPU in the memory of the switch or routers, e.g., routers 111-113 as described herein with reference to FIG. 1. As such, the present bundling methods and data structures of certain embodiments can be stored on a computer readable medium, e.g., RAM memory, ROM, magnetic or optical drive or diskette and the like.

Carrying Prefix Limits in the Open Capabilities

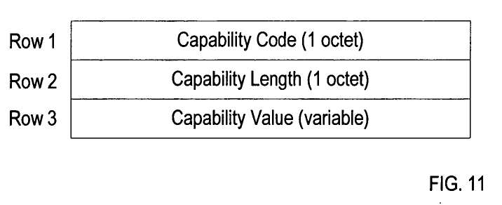

The BGP OPEN capabilities field uses the following triples: triples <Capability Code, Capability Length, Capability Value>. FIG. 11 illustrates the encoding of the triples of the BGP OPEN capabilities field, according to certain embodiments. The BGP Maximum Prefix Capability value to be assigned by IANA. Row 1 of FIG. 11 shows a capability code field of 1 octet. Row 2 shows capability length field of 1 octet. Row 3 shows capability value field. Interaction Between sub-codes 6-7 and sub-codes 1-3

Within the TLV, if sub-code 6 or sub-code 7 are specified, such sub-codes may not specify the 0/0 prefix length or an ORF match that matches all routes.

Carrying Maximum Prefix Limits in the Dynamic Open Capabilities

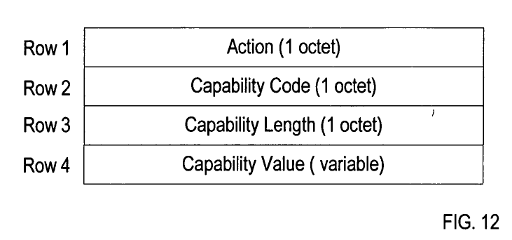

The BGP Dynamic Capabilities is carried in the Capability message (Message type 6). FIG. 12 illustrates the fields in the Capability message, according to certain embodiments. Row 1 of FIG. 12 shows an action filed of 1 octet. Row 2 shows a capability code field of 1 octet. Row 3 shows capability length field of 1 octet. Row 4 shows capability value field.

Action code of “0” in a dynamic capability adds the maximum preifx limits specified in the TLV for the corresponding AFI/SAFI. The Action code of “1” removes the prefix limits for a particular AFI/SAFI. An Action Code of “0” followed by an action code of “0” writes over the required fields, and provides an exclusive OR of the optional fields.

Carrying Maximum Prefix in ORF Match Field in BGP Route Refresh

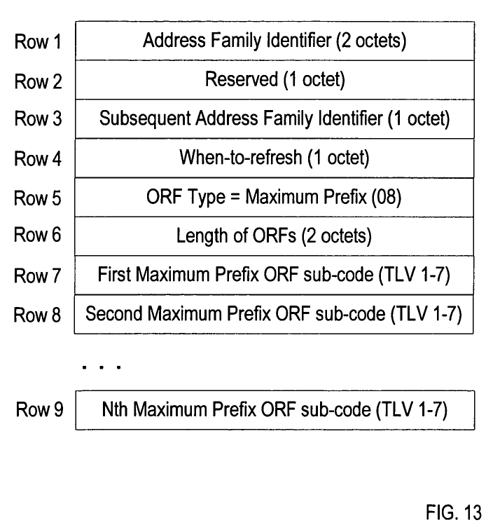

FIG. 13 illustrates the BGP Route-Refresh message [BGP-rr], according to certain embodiments. Row 1 shows an address family identifier field. Row 2 shows a reserved field, Row 3 shows a subsequent address family identifier field. Row 4 shows a when-to-refresh field. Row 5 shows an ORF Type=Maximum prefix field. Row 6 shows a length of ORFs field. Row 7 shows a first maximum prefix ORF sub-code (TLV 1-7) field. Row 8 shows a second maximum prefix ORF sub-code (TLV 1-7) field. Row N shows a Nth maximum prefix ORF sub-code (TLV 1-7) field.

ORF entries are carried in the BGP ROUTE-REFRESH message [BGP-RR]. A single ROUTE-REFRESH message could carry multiple ORF entries, as long as all these entries share the same AFI/SAFI. From the encoding point of view each ORF entry consists of a common part and type-specific part. The common part consists of <AFI/SAFI, ORF-Type, Action, Match>.

The “When-to-refresh” field in the route can be one of IMMEDIATE (0x01) or DEFER (0x02), the semantics and operation of which are described in [BGP-CRF]. Following this field is a collection of one or more ORFs, grouped by ORF-Type. The Maximum Prefix ORF type ORF field can be intermixed with other ORF fields. If the ORF field is specific to the Maximum Prefix field, the ORF (sub-code 7) is utilized to specify the ORF field.

The ORF-Type component is encoded as a one-octet field. The value 0 is reserved. The values currently proposed to be assigned are: 1) reserved (00), 2) Community (02), 3) Extended Community (03), 4) AsPath (xx), 5) Prefix (64), and 6) Maximum Prefix (08).

Carrying the Maximum Prefix in a Soft Notify

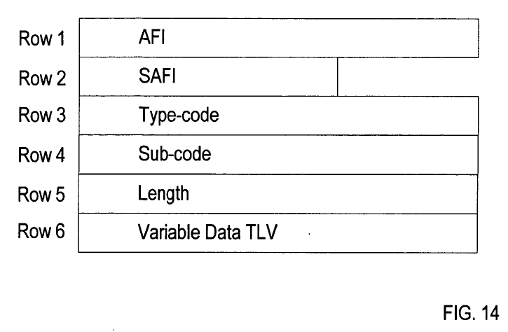

FIG. 14 illustrates a soft notify message, according to certain embodiments. Row 1 shows the AFI field. Row 2 shows the SAFI field. Row 3 shows the type-code field. Row 4 shows the sub-code field. Row 5 shows the length field. Row 6 shows variable data TLV field.

The type code of 3 will indicate that a prefix maximum has been exceeded. The sub-code will indicate which type of prefix maximum has been exceeded. The value of <1> will indicate a warning prefix maximum, the value of <2> will indicate that a stop advertisement prefix maximum has been exceeded, and the value of <0> will indicate that a reset peering advertisement has been exceeded.

The length specifies the length of the optional portion of the soft-notify. The variable portion of the soft-notify contains the required fields of the Maximum prefix field. The variable Data TLV MAY contain the fields of the optional fields.

Exchanging the Configured Prefix Limits

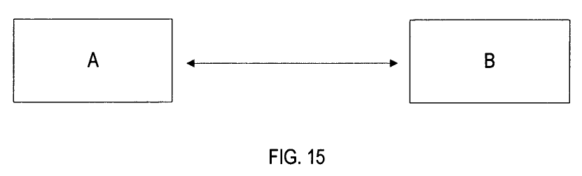

BGP speakers exchange the prefix limits as an optional capability parameter [BGP-CAP] as previously described herein. FIG. 15 illustrates BGP speakers A and B, according to certain embodiments. In FIG. 15 both BGP speakers A and B exchange the prefix limits to indicate the support for this capability. Each of A and B set the warning prefix limit, maximum prefix limit and reset prefix limit along with the actions associated with each of them in the capability message before exchanging them. The warning prefix limit and reset limit values are determined based on the configured maximum prefix limit. They are typically a percentage value of the maximum prefix limit. The maximum prefix limit configured on A for the peer B implies the maximum number of prefixes that A expects to receive from B. B informs this in the new capability previously described herein. The same interpretation applies to B too.

Dynamic Capability Reset of the Capability

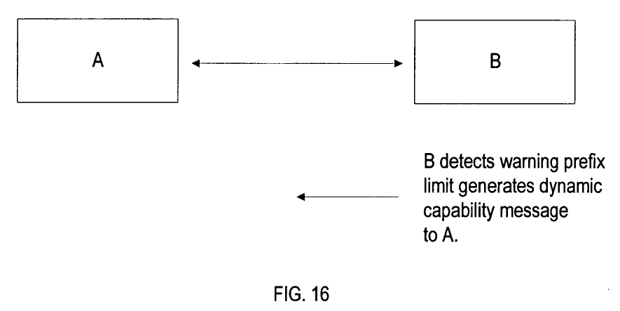

Dynamic Capabilities can set the BGP speakers maximum prefix values (warning indicator, stop advertisement, and reset peering values) to different values that initially negotiated via the OPEN Capabilities. FIG. 16 illustrates BGP speaker B detecting a warning message from A of a prefix limit, according to certain embodiments. FIG. 16 indicates how the dynamic capability can be utilized when a prefix limit is detected by the BGP speaker.

Dynamic Capability use of Sub-code 4 (Current Received Route) and Sub-Code 5 (Current Transmit Routes)

Sub-codes 4 (Current Received Routes) and sub-code 5 (current Transmit routes) provides information to the BGP speakers which aids in preventing peer disruption. FIG. 16 demonstrates the case where BGP speaker A and B maintain a count of the routes they receive from each other. Route processing operation is illustrated using the case where B sends route advertisements to A. The same operational procedures apply for the other case of A sending route advertisements to B.

B as shown in FIG. 15 applies the out bound route policies on the Adjacent-Rib-Out followed by the condition of the prefix limits before route advertisements. Upon hitting the warning indicator prefix limit, BGP speaker B sends the Dynamic Capability messages to A with 5 sub-codes: warning indicator (sub-code1), stop advertisement (sub-code 2), reset peering indicator (sub-code 3), Current Receive Routes (sub-code 4), Current Transmit routes (sub-code 5). The additional sub-codes, example sub-codes 4 and 5, provide information that assists the network administrators in prioritizing the handling of the warning. For example, if the limits are 1000 routes for warning, 2000 for stop advertisement, and 3000 for reset peering and the current routes are 1010. Then, it can be deduced by the network operator that the received routes are well within the tolerance limit, example sub-code 2. If instead for the same limits (1000,2000,3000), the current received routes (by speaker B) is 1900, the network operator may want to investigate the customer changes.

In FIG. 16, it can be seen in due course of route advertisements to A, B generates a dynamic capability [BGP-DYN-CAP] destined to A comprising the sub-codes 1-5. The reason B sends this message in this case is that it detects the warning limit at the time of route advertisements earlier than A. In other words either A or B or both of them could generate this message depending on timing of warning limit detection. B and A may choose to raise internal warning when this condition is detected. Following the warnings both A and B continue advertising routes normally to each other.

If B determines that the prefix limits can be increased, BGP speaker may send these changed values in the Dynamic capability along with sub-codes 1-5.

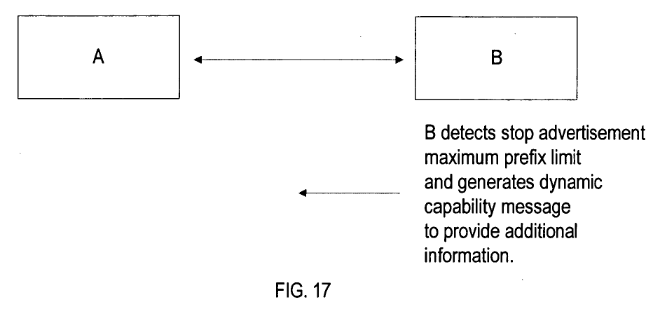

FIG. 17 illustrates BGP speaker B detecting a Stop Advertisement message from A, according to certain embodiments. In FIG. 17, B during route advertisement detects that the maximum prefix limit for route advertisement is reached. B stops further route advertisements to A. In other words in this condition, it implicitly means to B that the announce policy to A is stop/deny. B then sends a Dynamic Capability [BGP-DYN-CAP] to A indicating the current Receive and Transmit routes (sub-code 4 and Sub-cod 5). As in the case of warning prefix limit condition either A or B or both could send dynamic capability [BGP-DYN-CAP]. Any route withdrawal to A is automatically recorded and results in restoring the announce policy to the configured one (if any configured) implicitly. This helps in preserving the incremental nature of the protocol and avoiding processing of routes by peers such as B, which get discarded by speakers such as A when the limit is reached. In addition to these advantages, network bandwidth consumption by the route UPDATES can be avoided. It is expected that conformance to this document will not lead to any further route advertisements to A by B unless there exists an unforeseen error. Under such situation A can reset the peering session as indicated in the maximum prefix limit to B during the capability negotiation.

Prefix Limit Changes Utilizing Dynamic Capabilities

If a need for prefix limits change arises, each BGP speaker A whose configuration changes for its peer B, dynamically [BGP-DYN-CAP] informs the corresponding peer of this change. Such changes are handled as described in the following sub-sections.

Processing when Maximum Prefix Limit is Increased

When the prefix limits are increased in the configuration of A, in FIG. 15, A informs B about it as previously described herein. B then restarts the route advertisements and it may either choose to do so from the Adjacent-Rib-Out for A incrementally or make use of Route Refresh mechanism [BGP-RREFRESH], if it has stopped because of reaching the maximum prefix limit. The former methodology is similar to the approach taken prior to the introduction of Route Refresh. In other words it can be handled in the way policy changes were handled prior to the availability of Route Refresh mechanism, with a minor change of just sending the routes that were rejected due to the prefix limit. In doing so, the restart of BGP peering and the associated network traffic and service disruption with it, is avoided. If the maximum prefix limit is not reached and increased prefix limits are received by the peer B, then peer B notes this and continue with its advertisements to A until these limits are reached.

Processing when the Maximum Prefix Limit is Decreased

When the prefix limits are decreased in the configuration of A (refer FIG. 15), then B is informed about it as previously described herein. B then notes this information and stops route advertisement immediately if the number of route advertisements exceeds this new maximum prefix limit for A. By doing so B can avoid processing the routes which will be discarded by A when it detects the maximum prefix limit condition. A does this even before adding the routes to its Adjacent-Rib-In for the peer or in some cases restarting of the peering session. Additionally, network bandwidth consumption by the routing UPDATES can be avoided this way. B at that point follows the process described in 4.2 for route processing.

ORF Based Processing

The ORF filters can be carried either in the dynamic capability or in the Route Refresh message. The processing of the Route Refresh and ORF is described below.

Prefix Length Based Limits Processing

All of the operational procedures previously described herein are applicable to the negotiated prefix length based limits.

Error Handling

The Maximum prefix TLV can be sent in an OPEN (Message 1), a Route Refresh (message 5), or a capability (message 6). The sections below define the error codes and sub-codes related to these messages.

Open Message Responded to with Notification

OPEN messages can be rejected for the listed unsupported capabilities by the BGP speakers. The error code for an open message negotiation of Capabilities is sub-code 7 [BGP-CAP]. The maximum prefix TLV will be included in the list of capabilities.

Route Refresh Caused Notification Errors

[ROUTE-REFRESH] does not specify error messages associated with the Route-Refresh processing.

Capability Message Responded to with a Notification Errors

For errors in Dynamic Capabilities, a NOTIFICATION message may be sent with the Capability messages error code (7) [BGP-DYNCAP] set. Current sub-code for this error message are shown in Table 1 below:

TABLE 1

| Subcode | Symbolic Name |
|---|---|
| 1 | Invalid Action Value |
| 2 | Invalid Capability Length |
| 3 | Malformed Capability Value |
| 4 | Unsupported Capability Code |
| 5 | Invalid Capability Value |

Support for the Maximum Prefix value negotiations will require the addition of the following sub-code. If the Maximum Prefix code is not supported, the NOTIFICATION message will be returned with a error code of 7 with a sub-code of 4 (unsupported Capability Code). If the Maximum Prefix Capability is supported, but the value is not-acceptable to receiving node, the Notification can be sent with the 5 invalid capability value and the data field set to the Maximum Prefix TLVs that are not acceptable.

Cease Message For Peering Reset

When the reset maximum prefix value is exceeded, the peering session is dropped. In which case the CEASE code in the NOTIFICATION message will be used. The [CEASECODE] proposed BGP Draft gives a subcode of 1 for a Maximum prefix exceed. The data field has a maximum prefix upper bound. This field has a optional 1 octet field that allows a maximum prefix sub-codes to be encoded beyond this field.

Usage in Current Service Providers

The following is an example to illustrate a typical Service Provider's (SP) practice with maximum prefix limit. Providers can set one of three levels: Warning, Stop and Reset. This section provides an example of setting two limits (warning, stop/reset) versus three limits (warning, stop, reset).

Two Limits (Warning, Stop/Reset)

The provider may set two levels of threshold on the BGP receivers at the network edge:—low water mark as warning threshold and high water mark as stop/reset level. The high water mark has been thought of to quickly detect and stop a misconfigured router sending a full blast of Internet routers. However, the High water mark also may be exceeded in VPN clients by only a few routes as the routing tables grow.

Three Levels: Warning, Stop, Reset

With reference to the example above on the relation of provider and customer edge devices (BGP senders), it is proposed that both the customer and the provider participate in setting these three levels of thresholds: warning, stop, and reset, and reacting to the resulting warnings, traps or error messages. Anytime a threshold is set or changed on either side, it is communicated to the remote side via BGP signaling, and both sides communicate dynamically whenever an unexpected event triggers any of the threshold levels.

The warning level triggers the warning on both provider and customer edge devices, so customer can act on it without waiting for the provider to call. The second level triggers the customer edge device to stop sending routes, as it is reaching the agreed max prefix limit. This may also result in traps being issued on both customer and provider side. The idea is to have the customer take action to fix the problem without dropping the session, thereby requiring less human intervention from the provider side.

The third level triggers the session drop action from the provider side. This is used as safeguard for the providers network in case the customer edge device did not behave as expected and is continuing to send routes after exceeding the second level threshold. This feature can help both providers and customers to proactively manage their BGP connections by dynamic signaling, monitoring and taking corrective actions before any drastic action is necessary. In many cases, this can help avoid service interruption, avoid finger-pointing when sessions are dropped, lower operation cost, and increase customers satisfaction. In general, this feature can be applied to provider—provider peering connections as well, with similar advantages.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents. The specification and drawings are, accordingly, to be regarded in an illustrative rather than a restrictive sense.

What is claimed is:

1. A method for exchanging and processing route prefix limit messages in a communication network having a plurality of routers, wherein the plurality of routers exchange routing information at least partially via a Border Gateway Protocol (BGP), the method comprising:
negotiating at least one prefix limit parameter for addressing a prefix overload condition between said plurality of routers; and
performing route processing based on said at least one negotiated prefix limit parameter by at least one of said routers serving as at least one of a receiver and a sender;
wherein the at least one prefix limit parameters are exchanged via a BGP route refresh message.

2. The method of claim 1, wherein the at least one prefix limit parameters are contained in a Outbound Remote Filter (ORF) field of the route refresh message.

3. The method of claim 1, wherein said sender is a BGP sender and said receiver is a BGP receiver.

4. The method of claim 1, wherein said at least one prefix limit parameter defines a multi-level response to said prefix overload condition.

5. The method of claim 4, wherein said multi-level response comprises a tri-level response.

6. The method of claim 5, wherein a first level response of said tri-level response comprises:
triggering a warning on said at least one of said routers serving as at least one of a receiver and a sender when a first prefix limit of said at least one prefix limit parameter is reached.

7. The method of claim 6, wherein a second level response of said tri-level response comprises:
stopping route advertisement by said at least one of said routers serving as at least one of a receiver and a sender when a second prefix limit of said at least one prefix limit parameter is reached.

8. The method of claim 6, wherein a second level response of said tri-level response comprises:
sending a warning message by said receiver to said sender when a maximum prefix limit threshold of said at least one prefix limit parameter is reached.

9. The method of claim 7, wherein a third level response of said tri-level response comprises:
dropping a session by said at least one of said routers serving as at least one of a receiver and a sender when a third prefix limit of said at least one prefix limit parameter is reached.

10. The method of claim 1, wherein said at least one prefix limit parameter comprises at least one of:
a warning prefix limit parameter;
a maximum prefix limit parameter;
a reset prefix limit parameter;
a warning prefix limit action indicator;
a maximum prefix limit action indicator;
a reset prefix limit action indicator;
a current Rx routes parameter; and
a current Tx routes parameter.

11. The method of claim 1, further comprising:
sending said at least one prefix limit parameter by one of said routers serving as a receiver to one of said corresponding routers serving as a sender using a message;
sending an acknowledgement by said corresponding sender to said receiver if said at least one prefix limit parameter is supported and accepted by said sender; and
sending a notification by said corresponding sender to said receiver if said at least one prefix limit parameter is not supported by said sender.

12. The method of claim 11, further comprising:
reinitiating a session without said at least one prefix limit parameter by said receiver if said prefix limit negotiation has failed.

13. The method of claim 6, wherein said triggering said warning on said at least one of said routers comprises:
sending a warning message by said receiver to a corresponding sender when a warning prefix limit threshold of said at least one prefix limit parameter has been reached or exceeded.

14. A method for exchanging and processing route prefix limit messages in a communication network having a plurality of routers, wherein the plurality of routers exchange routing information at least partially via a Border Gateway Protocol (BGP), the method comprising:
negotiating at least one prefix limit parameter for addressing a prefix overload condition between said plurality of routers; and
performing route processing based on said at least one negotiated prefix limit parameter by at least one of said routers serving as at least one of a receiver and a sender;
wherein the at least one prefix limit parameters are exchanged via a BGP soft-notify message.
